(19) United States
(12) Patent Application Publication
(10) Pub. No.: US 2008/0090120 A1
(43) Pub. Date: Apr. 17, 2008

(54) FUEL REMAINING AMOUNT CALCULATION DEVICE FOR FUEL CONTAINER IN FUEL CELL DEVICE, FUEL CELL DEVICE, AND ELECTRIC POWER UTILIZING APPARATUS HAVING FUEL CELL DEVICE MOUNTED THEREON

(75) Inventor: Naoyo Gemma, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/867,488

(22) Filed: Oct. 4, 2007

(30) Foreign Application Priority Data
Oct. 17, 2006 (JP) 2006-282204

(51) Int. Cl. H01M 8/04; G01F 17/00

(52) U.S. Cl. 429/23; 73/149

(57) ABSTRACT

In order to provide a fuel remaining amount calculation device for a fuel container in a fuel cell device capable of accurately calculating a remaining amount of a fuel in a fuel container without using a special sensor, circuit or the like, and capable of achieving downsizing and cost reduction, and the like, the fuel remaining amount calculation device for calculating a fuel remaining amount in the fuel container includes: an apparatus operation vs fuel consumption amount conversion table for outputting fuel consumption amount data which is prepared in advance and which corresponds to an input of operation mode information of the electric power utilizing apparatus; a fuel consumption amount calculation unit for calculating a fuel consumption amount by using the fuel consumption amount data from the apparatus operation vs fuel amount consumption table; and a fuel remaining amount calculation unit for calculating the fuel remaining amount in the fuel container after use of electric power by the electric power utilizing apparatus from the fuel consumption amount calculated by the fuel consumption amount calculation unit and an original fuel remaining amount in the fuel container.

### BACKGROUND OF THE INVENTION

1. Field of the Invention

The present invention relates to a fuel remaining amount calculation device for a fuel container in a fuel cell device, the fuel cell device including the fuel remaining amount calculation device, and an electric power utilizing apparatus on which the fuel cell device is mounted.

2. Description of the Related Art

In a fuel cell, an energy capacity per volume and per weight can be dramatically increased compared to a conventional battery by supplying hydrogen serving as a fuel gas and oxygen (air) to generate an electromotive force in a power generation body. There is an expectation for a wide range of application of the fuel cell.

In particular, in recent years, there is a demand for the fuel cell to be quickly put into practical use because the fuel cell generates electric power with low pollution to a terrestrial environment and has a high electrical efficiency.

In general, an electric power utilizing apparatus utilizing a battery requires a function of accurately grasping a battery remaining amount and notifying a user of the battery remaining amount.

Thus, for a commonly known technology, a method of checking a voltage value is known as a method of accurately grasping the battery remaining amount.

Specifically, a battery voltage is monitored and when the battery voltage is equal to or more than a predetermined threshold value, indication “OK” is displayed. Alternatively, there is used, for example, a method of displaying a remaining amount corresponding to the voltage value.

For example, an alkali battery, a lithium secondary battery, a nickel-hydrogen secondary battery utilize characteristics thereof in which, in accordance with an electric power consumption, the battery voltage decreases at a constant rate.

However, in the fuel cell, regarding an electric power consumption time and a fuel cell output voltage, even though a fuel decreases, an output voltage maintains substantially a constant value.

The fuel cell has characteristics in which, when the fuel is used up, the output voltage is reduced to a level at which the electric power utilizing apparatus cannot be used.

Further, an output voltage has characteristics of being hardly dependent on a supply fuel pressure.

That is, in the fuel cell mounted to the electric power utilizing apparatus such as an electronic apparatus, the output voltage is maintained substantially constant even when the remaining amount of the fuel decreases. Therefore, detection of the remaining amount by monitoring a battery voltage is difficult.

That is, the discharging characteristics of the fuel cell is largely different from those of a battery such as a lithium ion secondary battery and the nickel-hydrogen secondary battery, and even when the remaining amount of the fuel decreases, an output voltage is maintained substantially constant. Accordingly, a system for detecting a remaining amount by monitoring the voltage of the battery cannot be used.

In view of this, for the system for detecting a remaining amount of a fuel in a fuel cell, there has been proposed various remaining amount detection methods except for the voltage monitoring.

Japanese Patent Application Laid-Open No. H11-230813 discloses a fluid remaining amount measuring device including a flowmeter for measuring a flow rate of a fuel, for computing a remaining amount of the fuel from an initial volume of the fuel and a used amount thereof measured by the flowmeter.

Further, Japanese Patent Application Laid-Open No. 2003-346856 discloses the following detection device of a remaining capacity of a fuel cell, for determining a remaining amount of a fuel.

That is, this device detects a supply amount of the fuel to be supplied to the fuel cell by using a flowmeter, adds a fuel cell capacity corresponding to the supply amount to a remaining capacity, and subtract the discharging capacity, which is computed from a discharging current detected by a current detection portion, from the remaining capacity, thereby calculating the remaining capacity.

Further, Japanese Patent Application Laid-Open No. 2003-346857 discloses a tank in which a product to be produced by the fuel cell is stored and a method of calculating a remaining amount of a fuel of the fuel cell according to an amount of the product stored in the tank.

Further, Japanese Patent Application Laid-Open No. 2004-171945 discloses a remaining amount detection method of a fuel cell for determining a remaining amount of a fuel according to a current capacity.

However, regarding the systems for detecting the remaining amount of the fuel cell according to the conventional examples, there are problems of achieving downsizing and cost reduction.

For example, the invention as disclosed in Japanese Patent Application Laid-Open No. H11-230813 according to the conventional example requires the expensive flowmeter for the remaining amount detection.

Further, the invention as disclosed in Japanese Patent Application Laid-Open No. 2003-346856 of the conventional example also requires the flowmeter for detecting the supply amount of the fuel and a current detection unit for detecting the discharge current supply amount.

Further, the invention as disclosed in Japanese Patent Application Laid-Open No. 2003-346857 of the conventional example requires the tank for storing the product produced in the fuel cell, a detection unit for detecting a storage amount of the product, and the like.

Thus, in those inventions, the structure of the device is complicated due to provision of the flowmeter, the detection unit, or the like, and those inventions have problems of downsizing and cost reduction.

Further, in an invention like the invention as disclosed in Japanese Patent Application Laid-Open No. 2004-171945, in which the remaining amount of the fuel is determined according to the current capacity, fuel use efficiency varies depending on a value of a current to be used. Accordingly, there is a problem in that, even when the same total current capacity is used with different current values being summed up, an amount of the used fuel is changed.

Further, it includes variable elements such as a current sensor accuracy, a resolution, a sampling period, and an AD conversion accuracy. Accordingly, the remaining amount of the fuel in a fuel tank cannot be accurately calculated in some cases.

Further, in fact, in an electronic apparatus or the like utilizing electric power supplied from the fuel cell, a current using pattern of an extraction current of the electronic apparatus is formed in complicated combination of various magnitudes and times of current according to the operation of the apparatus.

Accordingly, it is difficult to accurately calculate the fuel consumption amount with a uniform coefficient or the like.

Those will be described in detail with reference to the drawings.

FIG. 4 is a graph as an example illustrating the voltage-current characteristics of a fuel cell of a polymer electrolyte type, in which a plurality of fuel cell units are stacked.

The characteristic curve in FIG. 4 includes an operation point 401 at a small current, an operation point 402 at a medium current, and an operation point 403 at a large current. FIG. 4 shows a state where, when a current value is increased, an internal resistance increases so as to be larger at the operation point 402 than at the operation point 401 and larger at the operation point 403 than at the operation point 402, and an electric power utilization efficiency decreases.

FIG. 5 shows the results of measuring an extraction current and a fuel consumption amount in the fuel cell of the polymer electrolyte type, in which a plurality of fuel cell units are stacked.

The characteristic curve in FIG. 5 includes an operation point 501 at a small current, an operation point 502 at which a medium current, an operation point 503 at a large current.

FIG. 5 shows a state where, when a current value is increased, an inclination becomes larger at the operation point 502 than at the operation point 501 and larger at the operation point 503 than at the operation point 502.

The larger the extraction current is, the larger the fuel consumption amount per unit current becomes. Accordingly, FIG. 5 shows that a fuel consumption efficiency is low.

That is, when the same total current volume is extracted, when an extraction current is small, a fuel utilization efficiency is high, and when the extraction current is large, the fuel utilization efficiency is low.

When the extraction current is small, the fuel consumption per unit current is small, and when the extraction current is large, the fuel consumption per unit current is large.

In a case where consideration is made for the same total current capacity, when the extraction current is small, a fuel remaining amount is large, and when the extraction current is large, the fuel remaining amount is small.

In fact, the current using pattern of the extraction current of the electric power utilizing apparatus is formed in combination of various magnitudes and times of current according to the operation of the apparatus. Accordingly, it is difficult to accurately calculate the fuel consumption amount with a uniform coefficient or the like.

### SUMMARY OF THE INVENTION

The present invention is directed to a fuel remaining amount calculation device for a fuel container in a fuel cell device, a fuel cell device, and an electric power utilizing apparatus including the fuel cell device mounted thereon, capable of accurately calculating a remaining amount of a fuel in a fuel tank without using a special sensor, circuit, or the like, and capable of achieving downsizing and cost reduction.

The present invention provides the fuel remaining amount calculation device for the fuel container in the fuel cell device, the fuel cell device, and the electric power utilizing apparatus including the fuel cell device mounted thereon, which are structured as described below.

According to the present invention, there is provided a fuel remaining amount calculation device for a fuel container in a fuel cell device, for calculating a fuel remaining amount in the fuel container when an electric power generated by a fuel cell using a fuel supplied from the fuel container is supplied to an electric power utilizing apparatus, the fuel remaining amount calculation device including: an apparatus operation vs fuel consumption amount conversion table including fuel consumption data which is prepared in advance and which corresponds to an operation of the electric power utilizing apparatus, for outputting the fuel consumption amount data in respect of an input of operation mode information of the electric power utilizing apparatus; a fuel consumption amount calculation unit for calculating a fuel consumption amount by using the fuel consumption amount data output from the apparatus operation vs fuel consumption amount conversion table; and a fuel remaining amount calculation unit for calculating the fuel remaining amount in the fuel container after electric power is used by the electric power utilizing apparatus from the fuel consumption amount calculated by the fuel consumption amount calculation unit and an original fuel remaining amount in the fuel container.

Further, in the fuel remaining amount calculation device for a fuel container in a fuel cell device according to the present invention, the fuel container includes a fuel remaining amount storage unit for storing the fuel remaining amount calculated by the fuel remaining amount calculation unit.

Further, the fuel remaining amount calculation device for a fuel container in a fuel cell device according to the present invention further includes a unit for displaying one of the fuel consumption amount calculated by the fuel consumption calculation unit and the fuel remaining amount calculated by the fuel remaining amount calculation unit.

Further, in the fuel remaining amount calculation device for a fuel container in a fuel cell device according to the present invention, the fuel consumption amount calculation unit performs the calculation of the fuel consumption amount by the fuel consumption amount calculation unit using the fuel consumption amount data of the apparatus operation vs fuel consumption amount conversion table based on at least one of a one-shot operation in which a change pattern of a current value is determined and a operation duration time in which the current value is constant but a time is not constant.

Further, according to the present invention, there is provided a fuel cell device for supplying electric power generated by a fuel cell using a fuel supplied from a fuel container to an electric power utilizing apparatus, including the fuel remaining amount calculation device for a fuel container according to any one of the above-mentioned aspects.

Further, according to the present invention, there is provided an electric power utilizing apparatus utilizing electric power generated by a fuel cell using a fuel supplied from a fuel container, including the above-mentioned fuel cell device mounted on the electric power utilizing apparatus.

According to the present invention, there can be realized the fuel remaining amount calculation device for the fuel container in the fuel cell device, the fuel cell device, and the electric power utilizing apparatus including the fuel cell device mounted thereon, capable of accurately calculating the remaining amount of the fuel in the fuel container without using a special sensor, circuit, or the like, and capable of achieving downsizing and cost reduction.

Further features of the present invention will become apparent from the following description of exemplary embodiments with reference to the attached drawings.

### BRIEF DESCRIPTION OF THE DRAWINGS

FIG. 1 is a block diagram for describing a structure of a fuel remaining amount calculation device for a fuel container in a fuel cell device according to a first embodiment of the present invention.

FIG. 2 is a block diagram for describing a structure of a fuel remaining amount calculation device for a fuel container in a fuel cell device according to a second embodiment of the present invention.

FIG. 3 is a graph illustrating a current use state of an electric power utilizing apparatus utilizing a fuel cell.

FIG. 4 is a graph illustrating an example of output current-voltage characteristics of a fuel cell.

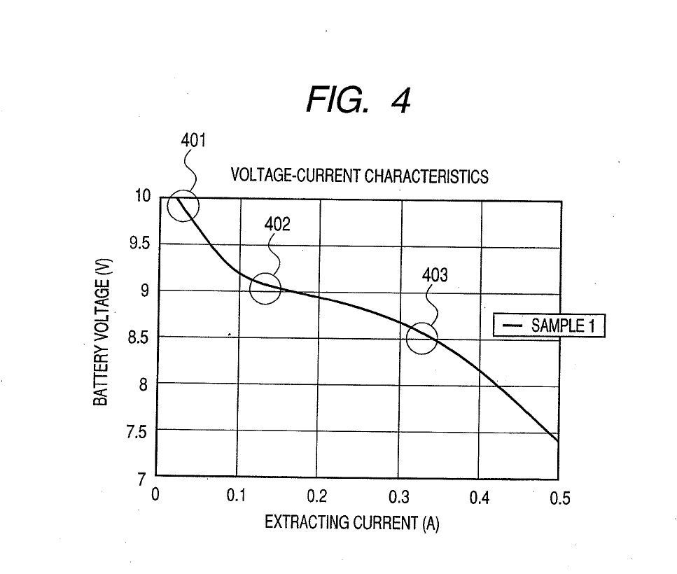

FIG. 5 is a graph illustrating an example of output current-fuel consumption amount characteristics of a fuel cell.

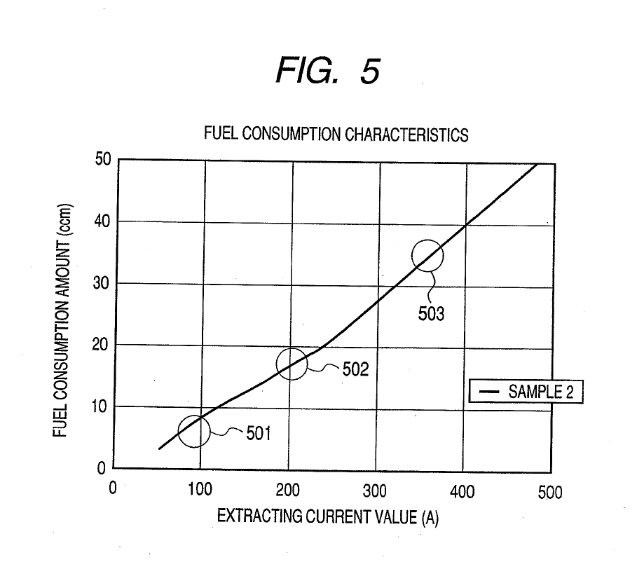

### DESCRIPTION OF THE EMBODIMENTS

Embodiments of the present invention will be described.

### First Embodiment

In a first embodiment of the present invention, a description will be made of a fuel remaining amount calculation device for a fuel container in a fuel cell device to which the present invention is applied.

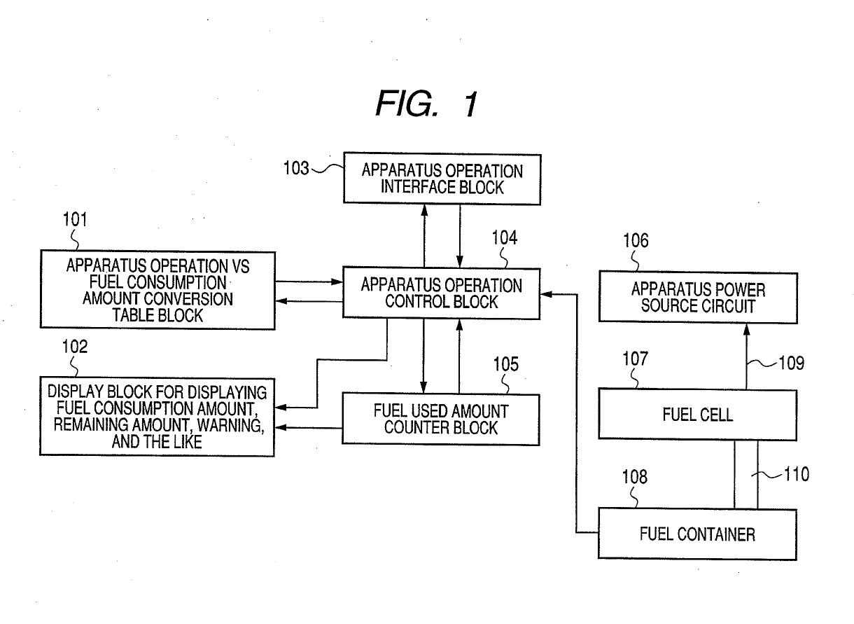

FIG. 1 illustrates a block diagram for describing a structure of the fuel remaining amount calculation device for the fuel container in this embodiment.

In FIG. 1, there is provided an apparatus operation vs fuel consumption amount conversion table block 101 for performing conversion between an apparatus operation and a fuel consumption amount.

The apparatus operation vs fuel consumption amount conversion table block 101 includes fuel consumption amount data prepared in advance, corresponding to the operation of an electric power utilizing apparatus and outputs the fuel consumption amount data in respect of an input of operation mode information.

Note that, an example of the electric power utilizing apparatus herein includes an electric power utilizing apparatus such as an electronic apparatus utilizing electric power generated by a fuel cell using a fuel from the fuel container.

A display block 102 stores a fuel consumption amount, a remaining amount, warning, and the like, and performs displaying for an operator performing an apparatus operation, and the like. An apparatus operation interface block 103 transmits a content of the apparatus operation to an apparatus control block 104.

A fuel used amount counter block 105 records and counts the obtained fuel consumption.

An apparatus power source circuit 106 transmits the output of a fuel cell 107 to an apparatus circuit.

A fuel container 108 supplies a fuel to the fuel cell 107. The fuel container 108 sends data of fuel remaining amount before use to the apparatus control block 104 before use.

An electric power transmission path 109 extends from the fuel cell 107 to the apparatus power source circuit 106.

A fuel flow path 110 supplies the fuel from the fuel container 110 to the fuel cell 107.

The apparatus control block 104 determines the apparatus operation according to the operation information transmitted from the apparatus operation interface block 103 which has received the operation from an apparatus operator, and issues an operation command to each portion. When the apparatus control block 104 starts the above-mentioned operation, the apparatus control block 104 sends operation mode information to the apparatus operation vs fuel consumption amount conversion table block 101. The apparatus operation vs fuel consumption amount conversion table block 101 sends data on the fuel consumption amount in the above-mentioned operation mode to the apparatus control block 104 as information.

The fuel consumption amount in one operation obtained as described above is recorded and counted in the fuel used amount counter block 105.

As a result, the total consumption amount of the fuel is computed. The before-use fuel remaining amount data obtained at a time of installation of the fuel container is subtracted from the total consumption amount of the fuel, thereby obtaining a fuel remaining amount value to display the fuel consumption amount or the fuel remaining amount by the display block 102.

The apparatus operation vs fuel consumption amount conversion table block 101 is prepared in advance by grasping a current value at the time of operation thereof in terms of a design based on characteristics of the fuel cell to be used or by actual measurement of the fuel consumption amount or the like at the time of operation in a manufacturing process.

The apparatus operation vs fuel consumption amount conversion table block 101 performs, in respect of the input of the operation mode, an operation for outputting the fuel consumption amount taking account of a fuel consumption efficiency changed by a current value.

With the structure according to this embodiment, the fuel used amount can be accurately calculated without a need of a special sensor or circuit, and the fuel remaining amount in the fuel container can thus be calculated.

### Second Embodiment

Next, a description will be made of a structural example in which a fuel container unit includes a fuel container and a fuel container storage block according to a second embodiment of the present invention.

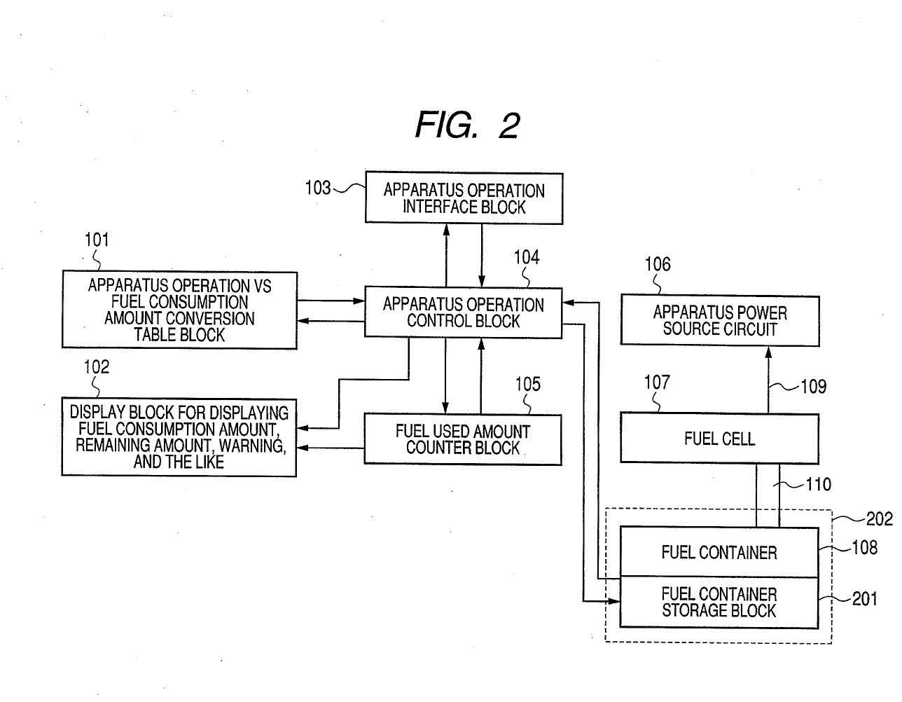

FIG. 2 illustrates a block diagram for describing a structural example according to the second embodiment of the present invention.

The block diagram of FIG. 2 illustrates an outline of an electric power utilizing apparatus having a feature that a fuel remaining amount in the fuel container after use is calculated from a fuel used amount calculated by the method of the first embodiment of the present invention and the original fuel remaining amount in the fuel container, and information including those is stored in the fuel container.

In FIG. 2, the same components as those of the first embodiment illustrated in FIG. 1 are denoted by the same reference numerals. Therefore, descriptions of common portions will be omitted.

A fuel container storage block 201 is integrated with the fuel container and is data-rewritable.

The fuel container storage block 201 is detachably attached to the fuel container 108 to constitute a fuel container unit 202.

The fuel container storage block 201 stores the fuel remaining amount. In addition thereto, information on the number of times of fuel filling, a full container capacity, and the like may be stored in the fuel container storage block 201.

In this embodiment, in a case where the fuel container unit 202 is removed, a final remaining amount is written into the fuel container storage block 201 of the fuel container unit 202 as remaining amount data by command from the apparatus control block 104.

Next, in a case where the fuel container unit 202 is mounted, reading of the remaining amount data is performed from the fuel container storage block 201 of the fuel unit 202 to determine an initial capacity value for calculation of the fuel remaining amount.

A timing to write the remaining amount data into the fuel container unit may be any timing as long as a value is reflected immediately before the removal.

With the structure of this embodiment, even when the fuel container unit 202 is removed at a midpoint of use, the fuel remaining amount at a time of next use can be accurately calculated.

### Third Embodiment

In a third embodiment of the present invention, a description will be made of a case where calculation of the fuel consumption amount by a fuel consumption amount calculation unit using fuel consumption amount data of an apparatus operation vs fuel consumption amount conversion table according to the present invention is performed based on at least one of a one-shot operation and an operation duration time.

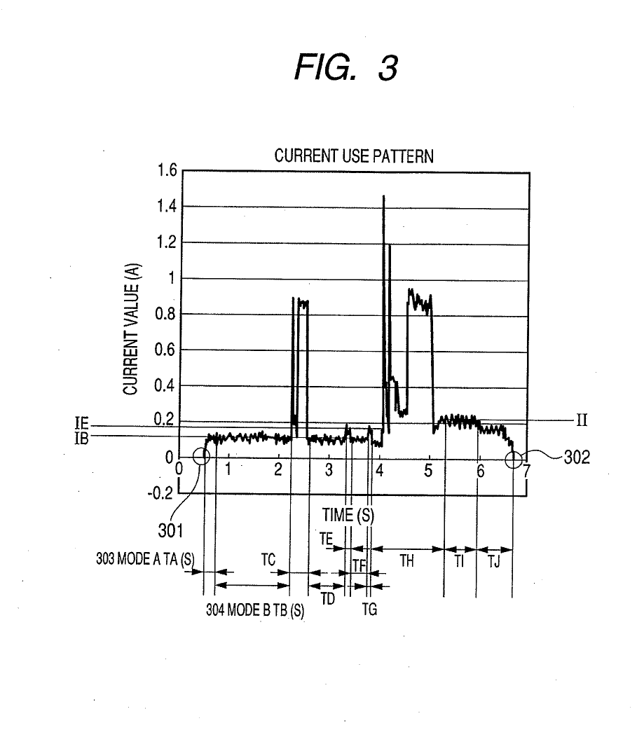

FIG. 3 is a graph illustrating a current use state of the electric power utilizing apparatus utilizing the fuel cell.

A current amount is changed variously depending on the operation with the elapse of time.

FIG. 3 illustrates a point 301 for switching on and a point 302 for switching off. A change pattern of a used current value from the point 301 at which the power source is switched on to the point 302 at which the power source is switched off after the operation is performed by the operator is illustrated.

One of operation modes of the electric power utilizing apparatus is a one-shot mode in which a change pattern of the current value is determined and in which the fuel consumption amount in the operation mode is determined.

Another of the operation modes is a mode based on the operation duration time, in which a current is constant and a time is not constant and in which the fuel consumption per unit time is determined.

According to the operation mode, the apparatus operation vs fuel consumption amount conversion table outputs the fuel consumption amount in the entire operation with respect to the one-shot mode and outputs data on the fuel consumption amount per unit time with respect to the mode based on the operation duration time.

In the one-shot mode, when the fuel consumption amount in the entire operation is output, it is directly counted as the fuel consumption.

In the mode based on the operation duration time, when the data on the fuel consumption amount per unit time is output, a product of the data on the fuel consumption amount per unit time and a duration time of the operation mode is counted as the fuel consumption.

Next, a description will be made of how the fuel consumption calculation is performed specifically by the electric power utilizing apparatus having those two modes.

A mode A period 303 is an initial operation period of starting of the power source of the electric power utilizing apparatus, in which the power source switch is turned on by an operator, whereby the electric power utilizing apparatus side operates in a predetermined current using pattern for a period TA(S).

A mode of this operation, for example, is a one-shot operation mode MA. According to the apparatus operation vs fuel consumption amount conversion table, the fuel consumption amount is counted as NA (cc).

After completion of this operation, the electric power utilizing apparatus waits for key entry by the operator.

In a case where this period is a mode B period 304, a fuel consumption amount SB (cc) per unit time is determined according to the apparatus operation vs fuel consumption amount conversion table obtained by a relationship between a use current value and the fuel consumption amount in this operation mode.

A fuel consumption amount NB (cc) consumed in the mode B period 304 is calculated from a time TB (S) of the mode B period 304 using the following equation, that is, NB(cc)=SB(cc/S)×TB(S).

In the same manner, after switching on, a fuel consumption amount NC (cc) is the fuel consumption amount in a one-shot operation in a mode of a timing TC, and at a timing TD, the same mode as the mode at a timing TB is used, and a fuel consumption amount per unit time is set to SB (cc/S).

In a mode at a timing TE, the fuel consumption amount per unit time with respect to a current value IE (A) is set to SE (cc/S). At a timing TF, the same mode as the mode at the timing TB is used, and a fuel consumption amount per unit time is set to SB (cc/S).

At a timing TG, similarly to the timing TE, a fuel consumption amount per unit time is set to SE (cc/S).

In a mode at a timing TH, the fuel consumption amount in the one-shot operation is set to NH (cc). In a mode at a timing TI, a fuel consumption amount per unit time with respect to a current value II(A) is set to SI (cc/S). At a timing TJ, a fuel consumption amount in the one-shot operation is set to NJ (cc).

Those values are obtained and counted according to the respective operation modes by using the apparatus operation vs fuel consumption conversion table.

A total fuel consumption amount NTOTAL (cc) until switching off is calculated by using the following equation, that is, NTOTAL(cc)=NA+SB×TB+NC+SB×TD+SE×TE+SB×TF+SE×TG+NH+SI×TI+NJ.

With the above-mentioned fuel consumption amount calculation unit, the fuel consumption can be accurately calculated in an operation whose time is not determined or a transient instantaneous operation, thereby enabling determination of the fuel remaining amount.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-282204, filed Oct. 17, 2006, which is hereby incorporated by reference herein in its entirety.

What is claimed is:

1. A fuel remaining amount calculation device for a fuel container in a fuel cell device, for calculating a fuel remaining amount in the fuel container when an electric power generated by a fuel cell using a fuel supplied from the fuel container is supplied to an electric power utilizing apparatus, the fuel remaining amount calculation device comprising:
an apparatus operation vs fuel consumption amount conversion table including fuel consumption data which is prepared in advance and which corresponds to an operation of the electric power utilizing apparatus, for outputting the fuel consumption amount data in respect of an input of operation mode information of the electric power utilizing apparatus;
a fuel consumption amount calculation unit for calculating a fuel consumption amount by using the fuel consumption amount data output from the apparatus operation vs fuel consumption amount conversion table; and
a fuel remaining amount calculation unit for calculating the fuel remaining amount in the fuel container after electric power is used by the electric power utilizing apparatus from the fuel consumption amount calculated by the fuel consumption amount calculation unit and an original fuel remaining amount in the fuel container.

2. A fuel remaining amount calculation device for a fuel container in a fuel cell device according to claim 1, wherein the fuel container comprises a fuel remaining amount storage unit for storing the fuel remaining amount calculated by the fuel remaining amount calculation unit.

3. A fuel remaining amount calculation device for a fuel container in a fuel cell device according to claim 1, further comprising a unit for displaying one of the fuel consumption amount calculated by the fuel consumption amount calculation unit and the fuel remaining amount calculated by the fuel remaining amount calculation unit.

4. A fuel remaining amount calculation device for a fuel container in a fuel cell device according to claim 1, wherein the fuel consumption amount calculation unit performs the calculation of the fuel consumption amount by the fuel consumption amount calculation unit using the fuel consumption amount data of the apparatus operation vs fuel consumption amount conversion table based on at least one of a one-shot operation in which a change pattern of a current value is determined and an operation duration time in which the current value is constant but a time is not constant.

5. A fuel cell device for supplying electric power generated by a fuel cell using a fuel supplied from a fuel container to an electric power utilizing apparatus, comprising the fuel remaining amount calculation device for a fuel container according to claim 1.

6. An electric power utilizing apparatus utilizing electric power generated by a fuel cell using a fuel supplied from a fuel container, comprising the fuel cell device according to claim 5 mounted on the electric power utilizing apparatus.
